(19) United States
(12) Patent Application Publication
(10) Pub. No.: US 2025/0265929 A1
(43) Pub. Date: Aug. 21, 2025

(54) DRIVING ASSISTANCE SYSTEM

(71) Applicant: TOYOTA JIDOSHA KABUSHIKI KAISHA, Toyota-shi (JP)

(72) Inventors: Shuntaro TSUTSUMI, Tokyo (JP); Masayuki KATOH, Tokyo (JP)

(73) Assignee: TOYOTA JIDOSHA KABUSHIKI KAISHA, Toyota-shi (JP)

(21) Appl. No.: 19/043,554

(22) Filed: Feb. 3, 2025

(30) Foreign Application Priority Data
Feb. 21, 2024 (JP) 2024-024342

(51) Int. Cl. G08G 1/16; G08G 1/01; G08G 1/0967

(52) U.S. Cl. CPC G08G 1/16; G08G 1/0129; G08G 1/0967

(57) ABSTRACT

A driving assistance system includes: a detection unit configured to detect a traffic participant present in a traveling direction of a vehicle; a database configured to store an appearance frequency of the traffic participant in association with a location on a map; an acquisition unit configured to acquire the appearance frequency at a location of the traffic participant detected by the detection unit based on the database; and a driving assistance unit configured to perform driving assistance including at least one of notifying a driver of the traffic participant detected by the detection unit and controlling the vehicle, in response to the appearance frequency acquired by the acquisition unit being less than or equal to a threshold.

### CROSS-REFERENCE TO RELATED APPLICATION

This application is based on Japanese Patent Application No. 2024-024342 filed with Japan Patent Office on Feb. 21, 2024, the entire contents of which are hereby incorporated by reference.

### TECHNICAL FIELD

The present disclosure relates to a driving assistance system.

### BACKGROUND

Japanese Patent Application Laid-Open No. 2015-207129 discloses a driving assistance system. This system performs a predetermined notification when it is determined that a pedestrian is walking on the roadway and the position of the pedestrian is within a predetermined range from the position of the vehicle.

### SUMMARY

In the system described in Japanese Patent Application Laid-Open No. 2015-207129, there is a risk that the driver may not be able to maintain attention. For example, in urban areas, the number of pedestrians is large, and the frequency of pedestrians entering the roadway is also high. Therefore, there is a risk that numerous notifications warning of pedestrians within the predetermined range from the vehicle's position may be issued. These numerous warnings may make it difficult for the driver to maintain attention. The present disclosure provides a driving assistance apparatus capable of performing driving assistance that allows the driver to maintain attention appropriately.

A driving assistance system according to an aspect of the present disclosure includes a detection unit configured to detect a traffic participant present in a traveling direction of a vehicle, a database configured to store an appearance frequency of the traffic participant in association with a location on a map, an acquisition unit configured to acquire the appearance frequency at a location of the traffic participant detected by the detection unit based on the database, and a driving assistance unit configured to perform driving assistance including at least one of notifying a driver of the traffic participant detected by the detection unit and controlling the vehicle, in response to the appearance frequency acquired by the acquisition unit being less than or equal to a threshold.

In this driving assistance system, a traffic participant present in the traveling direction of the vehicle is detected, and the appearance frequency at the location of the detected traffic participant is acquired based on the database that stores the appearance frequency of the traffic participant in association with the location on the map. Then, driving assistance including at least one of notifying the driver of the detected traffic participant and controlling the vehicle is performed in response to the acquired appearance frequency being less than or equal to the threshold. When the driver is always warned about predictable events, i.e., events with high appearance frequency, the driver may become accustomed to such events, leading to a decrease in attention. Conversely, for unpredictable events, i.e., events with low appearance frequency, it is difficult for the driver to maintain attention, and appropriate driving assistance is necessary. The driving assistance system performs driving assistance in response to the appearance of a traffic participant at a location where the appearance frequency is less than or equal to the threshold. This allows the driving assistance system to suppress notifications regarding traffic participants whose appearance can be predicted at the location, while ensuring notifications regarding traffic participants whose appearance is difficult to predict at the location. Therefore, the driving assistance system can perform driving assistance that allows the driver to maintain attention appropriately compared to a case where driving assistance is performed for all detected traffic participants.

In one embodiment, the detection unit may be further configured to detect a type of the traffic participant, the database may be further configured to store the type of the traffic participant in association with the appearance frequency, and the acquisition unit may be configured to acquire the appearance frequency based on information stored in the database and the type and location of the traffic participant detected by the detection unit. The driving assistance system can more appropriately determine whether the detected traffic participant is a traffic participant whose appearance can be predicted or a traffic participant whose appearance is difficult to predict by considering the difference in appearance frequency for each type of traffic participant.

In one embodiment, the database may be further configured to store the appearance frequency of the traffic participant in association with a date and time, and the acquisition unit may be configured to acquire the appearance frequency based on information stored in the database and the location and date and time of the traffic participant detected by the detection unit. The driving assistance system can more appropriately determine whether the detected traffic participant is a traffic participant whose appearance can be predicted or a traffic participant whose appearance is difficult to predict by considering the difference in appearance frequency for each date and time.

In one embodiment, the detection unit may be further configured to detect weather at a location where the traffic participant is detected, the database may be further configured to store the appearance frequency of the traffic participant in association with the weather, and the acquisition unit may be configured to acquire the appearance frequency based on information stored in the database and the location and weather of the traffic participant detected by the detection unit. The driving assistance system can more appropriately determine whether the detected traffic participant is a traffic participant whose appearance can be predicted or a traffic participant whose appearance is difficult to predict by considering the difference in appearance frequency for each weather condition.

In one embodiment, the driving assistance unit may be configured to perform the driving assistance in response to the traffic participant detected by the detection unit approaching the vehicle. The driving assistance system can more appropriately determine whether to perform the driving assistance by considering the movement of the detected traffic participant.

In one embodiment, the driving assistance unit may be configured to perform the driving assistance in response to the appearance frequency acquired by the acquisition unit being less than or equal to the threshold and the current situation corresponding to at least one of the following conditions: the driver is driving on a road for the first time, the vehicle speed exceeds a predetermined speed, a driver monitor detects the driver looking away, and accident statistics exceed the threshold. This driving assistance system can perform driving assistance when the current situation is one where unexpected events are likely to occur or difficult to handle, in addition to the appearance of a traffic participant with a low appearance frequency. This allows the driving assistance system to more appropriately determine whether to perform the driving assistance by considering the current situation.

According to the present disclosure, driving assistance that allows the driver to maintain attention appropriately can be performed.

### BRIEF DESCRIPTION OF DRAWINGS

FIG. 1 is a schematic diagram showing an example of the configuration of a driving assistance system according to an embodiment.

FIG. 2 is an example of information stored in the appearance frequency database.

FIG. 3 is a flowchart showing an example of the operation of the driving assistance system according to an embodiment.

FIG. 4 is a schematic diagram showing an example of the configuration of a driving assistance system according to a modification.

### DETAILED DESCRIPTION

Hereinafter, embodiments of the present disclosure will be described with reference to the drawings. In the description of the drawings, the same reference numerals are given to the same elements, and redundant explanations are not repeated.

### Overview of the Driving Assistance System

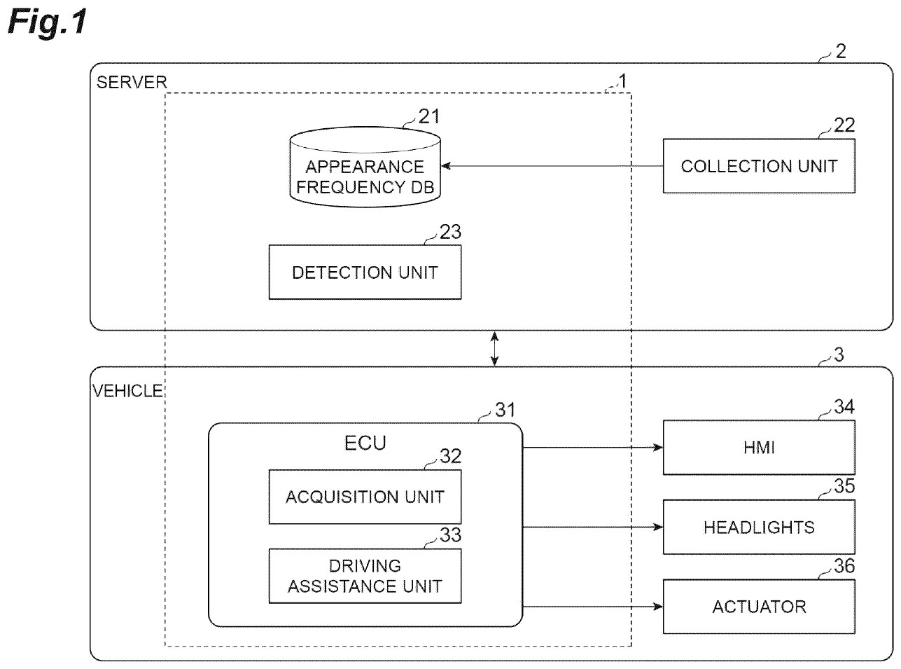

FIG. 1 is a schematic diagram showing an example of the configuration of a driving assistance system according to an embodiment. The driving assistance system 1 shown in FIG. 1 is realized by a server 2 and a vehicle 3, and provides driving assistance to the driver of the vehicle 3. The server 2 is a computer having a CPU (Central Processing Unit), ROM (Read Only Memory), RAM (Random Access Memory), a communication circuit, and the like. The server 2 is configured to communicate with the vehicle 3. The server 2 may be configured to communicate with other vehicles besides the vehicle 3. The vehicle 3 may be a vehicle driven by a driver or an autonomous vehicle.

The server 2 includes an appearance frequency DB 21 (an example of a database), a collection unit 22, and a detection unit 23. The collection unit 22 and the detection unit 23 are functional configurations realized by the above-described hardware. The collection unit 22 is not a required configuration of the server 2 and may be provided as needed.

The appearance frequency DB 21 is a database configured to store the appearance frequency of traffic participants in association with locations on a map. Traffic participants are people or objects present in the traffic environment, such as pedestrians. Traffic participants may also include bicycles, motorcycles, vehicles, and the like. The appearance frequency of traffic participants indicates the number of traffic participants counted within a predetermined time at a predetermined location. The predetermined time may be, for example, one hour, several hours, one day, one month, one year, and so on. The appearance frequency of traffic participants may also be a value obtained by dividing the number of traffic participants counted during a certain time period by the total number of traffic participants counted throughout the day. In other words, the appearance frequency of traffic participants may be calculated as a daily average value. Similarly, the appearance frequency of traffic participants may be calculated as an average value over several hours, a monthly average value, or an annual average value.

The appearance frequency DB 21 may further store the type of traffic participants in association with the appearance frequency. The type of traffic participants is information for distinguishing between pedestrians, bicycles, motorcycles, vehicles, and the like. In other words, the appearance frequency DB 21 can store the appearance frequency for each type of traffic participant, even at the same location on the map.

The appearance frequency DB 21 may further store the appearance frequency of traffic participants in association with the date and time. The date and time may be, for example, the time, time zone, date, and so on. In other words, the appearance frequency DB 21 can store the appearance frequency of traffic participants for each date and time, even at the same location on the map.

The appearance frequency DB 21 may further store the appearance frequency of traffic participants in association with the weather. The weather may be, for example, sunny, rainy, cloudy, thunderstorm, and so on. In other words, the appearance frequency DB 21 can store the appearance frequency of traffic participants for each weather condition, even at the same location on the map.

The information in the appearance frequency DB 21 is stored and updated by the collection unit 22. The collection unit 22 obtains information on traffic participants by communicating with external sources and stores the obtained information in the appearance frequency DB 21. For example, the collection unit 22 may communicate directly with mobile devices owned by traffic participants or with external servers that can communicate with such mobile devices to obtain location information (device location information) of the mobile devices. The location information of the mobile devices is used as the location information of the traffic participants. The collection unit 22 updates the appearance frequency stored in the appearance frequency DB 21 based on the location information of the mobile devices. The collection unit 22 may also obtain the type of traffic participants, date and time, and weather from the mobile devices or external servers, in addition to the location information of the mobile devices. The collection unit 22 may update the appearance frequency stored in the appearance frequency DB 21 based on the obtained type of traffic participants, date and time, and weather. The collection unit 22 is not limited to communicating with mobile devices and external servers owned by traffic participants, and may also communicate with infrastructure equipment such as cameras or sensors installed on roads, or vehicles equipped with onboard cameras or sensors.

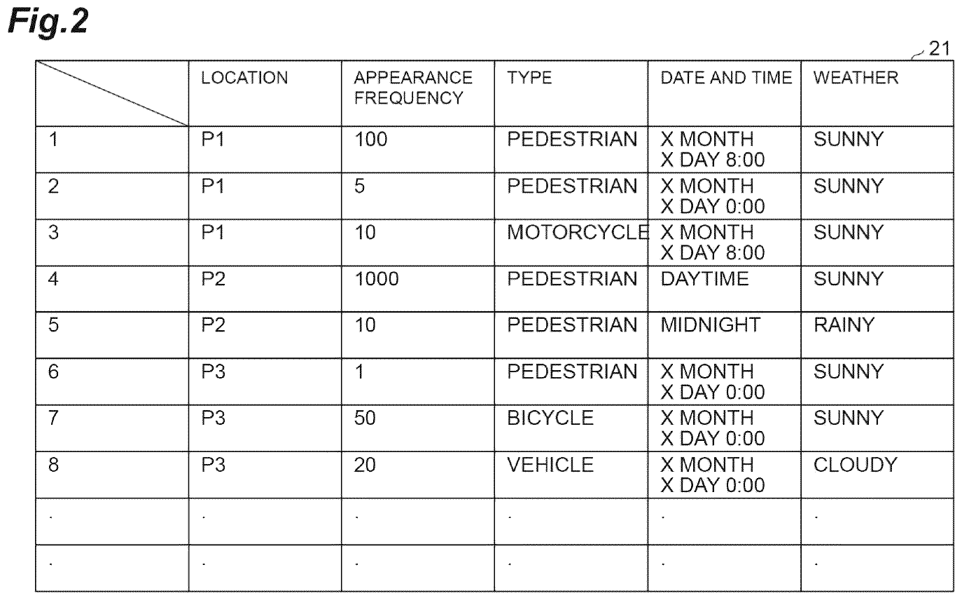

FIG. 2 is an example of information stored in the appearance frequency database. As shown in FIG. 2, the appearance frequency DB 21 stores the appearance frequency in association with locations on the map. For example, in item number “1”, the appearance frequency “100” is stored in association with location “P1”. The appearance frequency in FIG. 2 indicates the appearance frequency per hour as an example. In item number “1”, the type “pedestrian”, date and time “x month x day 8:00”, and weather “sunny” are further stored in association with location “P1”. When the date and time include the time, the appearance frequency may be calculated as the appearance frequency per hour including that time. For example, in the case of date and time “x month x day 8:00”, the appearance frequency may be the appearance frequency per hour from 8:00 to 9:00 on x month x day.

Similarly, in item number “2”, the appearance frequency “5”, type “pedestrian”, date and time “x month x day 0:00”, and weather “sunny” are stored in association with location “P1”. In item number “3”, the appearance frequency “10”, type “motorcycle”, date and time “x month x day 8:00”, and weather “sunny” are stored in association with location “P1”.

In item number “4”, the appearance frequency “1000”, type “pedestrian”, date and time “daytime”, and weather “sunny” are stored in association with location “P2”. In item number “5”, the appearance frequency “10”, type “pedestrian”, date and time “midnight”, and weather “rainy” are stored in association with location “P2”.

In item number “6”, the appearance frequency “1”, type “pedestrian”, date and time “x month x day 0:00”, and weather “sunny” are stored in association with location “P3”. In item number “7”, the appearance frequency “50”, type “bicycle”, date and time “x month x day 0:00”, and weather “sunny” are stored in association with location “P3”. In item number “8”, the appearance frequency “20”, type “vehicle”, date and time “x month x day 0:00”, and weather “cloudy” are stored in association with location “P3”. Subsequent item numbers are omitted.

As described above, in the appearance frequency DB 21, the location, type, date and time, and weather are stored in association with the appearance frequency.

Returning to FIG. 1, the detection unit 23 of the server 2 detects traffic participants present in the traveling direction of the vehicle 3. The detection unit 23 can detect traffic participants present in the traveling direction of the vehicle 3 based on various information.

For example, the detection unit 23 may detect traffic participants present in the traveling direction of the vehicle 3 based on the location information (device location information) of mobile devices owned by traffic participants. The device location information is obtained directly from the mobile devices or via other servers. The detection unit 23 may, for example, calculate the travel route from the traveling direction of the vehicle 3 or obtain the travel route from the vehicle 3. Then, the detection unit 23 detects traffic participants present in the traveling direction of the vehicle 3 by matching the calculated or obtained travel route with the device location information.

The detection unit 23 may detect traffic participants present in the traveling direction of the vehicle 3 based on infrastructure information. The infrastructure information is information detected by cameras or sensors installed on roads and includes the location information of detected traffic participants. The infrastructure information is obtained directly from the infrastructure equipment or via other servers. The detection unit 23 detects traffic participants present in the traveling direction of the vehicle 3 by matching the calculated or obtained travel route of the vehicle 3 with the infrastructure information.

The detection unit 23 may detect traffic participants present in the traveling direction of the vehicle 3 based on sensor information. The sensor information is information detected by onboard cameras or onboard radars of other vehicles and includes the location information of detected traffic participants. The sensor information is obtained directly from other vehicles or via other servers. The detection unit 23 detects traffic participants present in the traveling direction of the vehicle 3 by matching the calculated or obtained travel route of the vehicle 3 with the sensor information.

When the detection unit 23 detects traffic participants present in the traveling direction of the vehicle 3, the server 2 transmits the location of the detected traffic participants to the vehicle 3. The server 2 may transmit not only the location of the detected traffic participants but also information including the type, date and time, weather, and the like.

The vehicle 3 includes an ECU (Electronic Control Unit) 31, an HMI (Human-Machine Interface) 34, headlights 35, and an actuator 36. The vehicle 3 does not necessarily include all of the HMI 34, headlights 35, and actuator 36, and may include at least one of these components.

The ECU 31 is a computer having a CPU, ROM, RAM, a communication circuit, and the like. The ECU 31 includes an acquisition unit 32 and a driving assistance unit 33 as functional configurations. The acquisition unit 32 and the driving assistance unit 33 are realized by the above-described hardware.

When the acquisition unit 32 receives the location of the traffic participants present in the traveling direction of the vehicle 3, it acquires the appearance frequency at the location of the traffic participants based on the appearance frequency DB 21. The acquisition unit 32 uses the location of the traffic participants as a search key and inquires the server 2 to acquire the appearance frequency corresponding to the location of the traffic participants from the appearance frequency DB 21. The acquisition unit 32 may acquire the appearance frequency from the appearance frequency DB 21 based on not only the location of the detected traffic participants but also the type, date and time, and weather of the detected traffic participants. By setting detailed search conditions, more appropriate appearance frequency can be acquired.

The driving assistance unit 33 determines whether the appearance frequency acquired by the acquisition unit 32 is less than or equal to the threshold. The threshold is set in advance to determine the appearance frequency. The threshold is set to determine whether the location is a location where traffic participants frequently appear by analyzing the appearance frequency of all locations. The threshold may be determined using statistical methods (e.g., mean value or median value) or may be set empirically. A location where the appearance frequency is less than or equal to the threshold is considered a location where traffic participants do not frequently appear. Therefore, the situation where traffic participants appear at a location where the appearance frequency is less than or equal to the threshold is a situation that is difficult for the driver to handle, i.e., a situation where attention is likely to decrease. Attention is synonymous with vigilance, wakefulness, concentration, and is an indicator of reaction delay. Therefore, a location where the appearance frequency is less than or equal to the threshold is a location where driving assistance should be performed.

The driving assistance unit 33 performs driving assistance in response to the appearance frequency being less than or equal to the threshold. The driving assistance includes at least one of notifying the driver of the traffic participants detected by the detection unit 23 and controlling the vehicle 3.

The notification to the driver by the driving assistance unit 33 is performed via the HMI 34. The HMI 34 is a device for realizing communication between the vehicle 3 and the driver, and includes, for example, a touch display, a speaker, and the like. The driving assistance unit 33 may display the location of the detected traffic participants on the map on the display, may display the location of the detected traffic participants in text, or may output the location of the traffic participants via the speaker. The information notified to the driver may include not only the location of the traffic participants but also other information such as the type.

The control of the vehicle 3 by the driving assistance unit 33 is control to mitigate situations where attention is likely to decrease. For example, the driving assistance unit 33 performs lighting control of the headlights 35 to mainly illuminate the location of the detected traffic participants. The headlights 35 are, for example, multiple lights arranged in the vehicle width direction, and are configured to control the illumination position by the lighting position of each light. The headlights 35 may be configured to change the illumination position by including an actuator. The lighting by the headlights 35 can create a situation where the driver can easily notice the traffic participants.

The control of the vehicle 3 by the driving assistance unit 33 may be control to avoid situations where attention is likely to decrease. For example, the driving assistance unit 33 may operate the actuator 36 to decelerate the vehicle 3 or to steer the vehicle 3 away from the location of the traffic participants. The actuator 36 may include an engine actuator, a brake actuator, and a steering actuator.

The driving assistance unit 33 may determine whether to perform the driving assistance by adding various conditions in addition to the condition that the appearance frequency acquired by the acquisition unit 32 is less than or equal to the threshold. For example, the driving assistance unit 33 may perform the driving assistance in response to the traffic participants detected by the detection unit 23 approaching the vehicle 3. For example, the driving assistance unit 33 may sequentially acquire the location of the traffic participants from the detection unit 23 and determine whether the distance between the traffic participants and the vehicle 3 is decreasing based on the time change of the location. This allows the driving assistance unit 33 to avoid performing ineffective driving assistance when the traffic participants are not approaching the vehicle 3.

The driving assistance unit 33 may perform the driving assistance when the current situation is a road the driver is driving on for the first time, in addition to the determination of the appearance frequency. For example, the driving assistance unit 33 may determine whether the current road is a road the driver is driving on for the first time based on the driving history.

The driving assistance unit 33 may perform the driving assistance when the current situation is a road the driver is driving on for the first time, in addition to the determination of the appearance frequency. For example, the driving assistance unit 33 may determine whether the current road is a road the driver is driving on for the first time based on the driving history. A road being driven for the first time is a situation where there is no accumulated experience, and the driver has to react to all events, making it a situation where attention is likely to decrease. The driving assistance unit 33 can break through the situation where attention is likely to decrease and maintain the driver's attention appropriately by performing the driving assistance when the appearance frequency acquired by the acquisition unit 32 is less than or equal to the threshold and the current road is a road the driver is driving on for the first time.

The driving assistance unit 33 may perform the driving assistance when the vehicle speed exceeds a predetermined speed, in addition to the determination of the appearance frequency. The predetermined speed can be set as appropriate, and may be set to about 90% of the speed limit as an example. For example, the driving assistance unit 33 may acquire the predetermined speed of the road being traveled based on infrastructure information, and determine whether the vehicle speed exceeds the predetermined speed by comparing the acquired predetermined speed with the vehicle speed of the vehicle 3. The situation where the vehicle speed exceeds the predetermined speed is a situation where it is difficult to handle unexpected events. The driving assistance unit 33 can break through the situation where attention is likely to decrease and maintain the driver's attention appropriately by performing the driving assistance when the appearance frequency acquired by the acquisition unit 32 is less than or equal to the threshold and the vehicle speed exceeds the predetermined speed.

The driving assistance unit 33 may perform the driving assistance when a driver monitor detects the driver looking away, in addition to the determination of the appearance frequency. The driver monitor is an image sensor provided in the cabin of the vehicle 3 to monitor the driver. For example, the driving assistance unit 33 may detect the driver looking away based on the image captured by the driver monitor. The situation where the driver is looking away is a situation where it is difficult to handle unexpected events. The driving assistance unit 33 can break through the situation where attention is likely to decrease and maintain the driver's attention appropriately by performing the driving assistance when the appearance frequency acquired by the acquisition unit 32 is less than or equal to the threshold and the driver monitor detects the driver looking away.

The driving assistance unit 33 may perform the driving assistance when accident statistics exceed the threshold, in addition to the determination of the appearance frequency. The accident statistics are obtained, for example, from an external server. The threshold is set in advance to determine the number of accidents. The threshold may be determined using statistical methods (e.g., mean value or median value) or may be set empirically. The situation where the accident statistics exceed the threshold is likely to be a situation where it is difficult to handle unexpected events, such as a place with poor visibility. The driving assistance unit 33 can break through the situation where attention is likely to decrease and maintain the driver's attention appropriately by performing the driving assistance when the appearance frequency acquired by the acquisition unit 32 is less than or equal to the threshold and the accident statistics exceed the threshold.

The driving assistance unit 33 may ultimately determine whether to perform the driving assistance by combining the above-described situation determinations in addition to the determination of the appearance frequency. For example, the driving assistance unit 33 may perform the driving assistance when several of the above-described situations are met.

### Operation of the Driving Assistance System

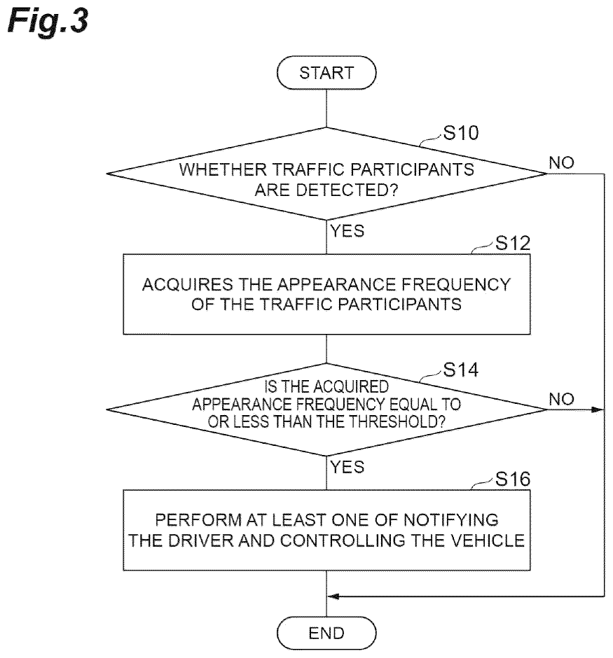

FIG. 3 is a flowchart showing an example of the operation of the driving assistance system according to an embodiment. The flowchart shown in FIG. 3 is executed when the driver of the vehicle 3 instructs the start of the driving assistance system service. As shown in FIG. 3, first, the server 2 determines whether traffic participants present in the traveling direction of the vehicle 3 are detected by the detection unit 21 in step S10.

When traffic participants are detected (YES in step S10), the acquisition unit 32 receives the location of the traffic participants present in the traveling direction of the vehicle 3 and acquires the appearance frequency at the location of the traffic participants by inquiring the server 2, in step S12.

Subsequently, the driving assistance unit 33 determines whether the acquired appearance frequency is less than or equal to the threshold in step S14. When it is determined that the acquired appearance frequency is less than or equal to the threshold (YES in step S14), the driving assistance unit 33 performs the driving assistance in step S16. When step S16 ends, the flowchart shown in FIG. 3 ends.

When traffic participants are not detected (NO in step S10) or when it is determined that the appearance frequency is not less than or equal to the threshold (NO in step S14), the driving assistance is not performed, and the flowchart shown in FIG. 3 ends.

When the flowchart shown in FIG. 3 ends, the processing is executed from the beginning of the flowchart until the end condition is met. The end condition may be met, for example, when the driver instructs the end of the driving assistance system service.

### Summary of the Embodiment

In the driving assistance system 1, traffic participants present in the traveling direction of the vehicle 3 are detected, and the appearance frequency at the location of the detected traffic participants is acquired based on the appearance frequency DB 21 that stores the appearance frequency of traffic participants in association with locations on the map. Then, driving assistance including at least one of notifying the driver of the detected traffic participants and controlling the vehicle 3 is performed in response to the acquired appearance frequency being less than or equal to the threshold. If the driver is always warned about predictable events, i.e., events with high appearance frequency, the driver may become accustomed to such events, leading to a decrease in attention. Conversely, for unpredictable events, i.e., events with low appearance frequency, it is difficult for the driver to maintain attention, and appropriate driving assistance is necessary. The driving assistance system 1 performs driving assistance in response to the appearance of a traffic participant at a location where the appearance frequency is less than or equal to the threshold. This allows the driving assistance system 1 to suppress notifications regarding traffic participants whose appearance can be predicted at the location, while ensuring notifications regarding traffic participants whose appearance is difficult to predict at the location. Therefore, the driving assistance system 1 can perform driving assistance that allows the driver to maintain attention appropriately compared to a case where driving assistance is performed for all detected traffic participants.

Various exemplary embodiments have been described above, but various omissions, substitutions, and changes may be made without being limited to the exemplary embodiments described above.

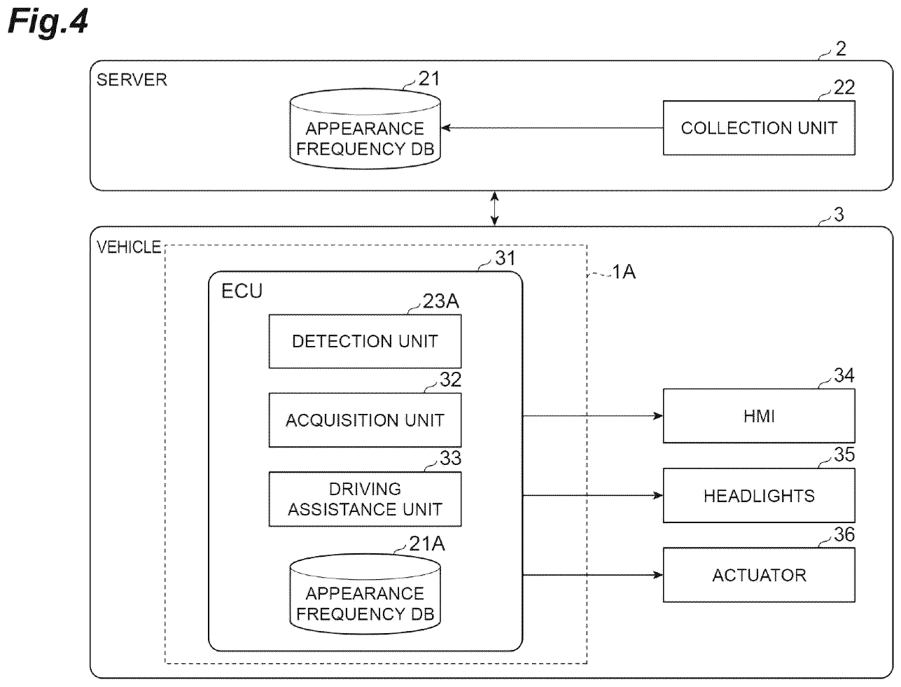

For example, each configuration of the driving assistance system 1 may be provided in either the server 2 or the vehicle 3, and is not limited to the form shown in FIG. 1. As an example, a case where all configurations are present in the vehicle is illustrated. FIG. 4 is a schematic diagram showing an example of the configuration of a driving assistance system according to a modification. The driving assistance system 1A shown in FIG. 4 differs from the driving assistance system 1 shown in FIG. 1 in that the server 2 does not include the detection unit 23, and the vehicle 3 includes a detection unit 23A and an appearance frequency DB 21A, while the other configurations are the same. The differences from the driving assistance system 1 will be mainly described below, and redundant explanations will be omitted.

As shown in FIG. 4, the ECU 31 includes a detection unit 23A, an acquisition unit 32, a driving assistance unit 33, and an appearance frequency DB 21A. The detection unit 23A detects traffic participants present in the traveling direction of the vehicle 3, similarly to the detection unit 23. The detection unit 23A is functionally the same as the detection unit 23, and the only difference may be the route for obtaining the information used for detection. The appearance frequency DB 21A is a database updated based on the appearance frequency DB 21. For example, the appearance frequency DB 21A is copied (synchronized) from the appearance frequency DB 21 at a predetermined timing. In other words, the appearance frequency DB 21A has the same information as the appearance frequency DB 21, although the freshness of the information may vary. The update timing is set as appropriate.

The above-described driving assistance system 1A can operate similarly to the driving assistance system 1 and can perform driving assistance that allows the driver to maintain attention appropriately.

What is claimed is:

1. A driving assistance system comprising:
a detection unit configured to detect a traffic participant present in a traveling direction of a vehicle;
a database configured to store an appearance frequency of the traffic participant in association with a location on a map;
an acquisition unit configured to acquire the appearance frequency at a location of the traffic participant detected by the detection unit based on the database; and
a driving assistance unit configured to perform driving assistance including at least one of notifying a driver of the traffic participant detected by the detection unit and controlling the vehicle, in response to the appearance frequency acquired by the acquisition unit being less than or equal to a threshold.

2. The driving assistance system according to claim 1, wherein
the detection unit is further configured to detect a type of the traffic participant,
the database is further configured to store the type of the traffic participant in association with the appearance frequency, and
the acquisition unit is configured to acquire the appearance frequency based on information stored in the database and the type and location of the traffic participant detected by the detection unit.

3. The driving assistance system according to claim 1, wherein
the database is further configured to store the appearance frequency of the traffic participant in association with a date and time, and
the acquisition unit is configured to acquire the appearance frequency based on information stored in the database and the location and date and time of the traffic participant detected by the detection unit.

4. The driving assistance system according to claim 1, wherein
the detection unit is further configured to detect weather at a location where the traffic participant is detected,
the database is further configured to store the appearance frequency of the traffic participant in association with the weather, and
the acquisition unit is configured to acquire the appearance frequency based on information stored in the database and the location and weather of the traffic participant detected by the detection unit.

5. The driving assistance system according to claim 1, wherein the driving assistance unit is configured to perform the driving assistance in response to the traffic participant detected by the detection unit approaching the vehicle.

6. The driving assistance system according to claim 1, wherein the driving assistance unit is configured to perform the driving assistance in response to the appearance frequency acquired by the acquisition unit being less than or equal to the threshold and a current situation corresponding to at least one of following conditions: the driver is driving on a road for a first time, a vehicle speed exceeds a predetermined speed, a driver monitor detects driver looking away, and accident statistics exceed the threshold.
